(19) United States
(12) Patent Application Publication
(10) Pub. No.: US 2025/0315939 A1
(43) Pub. Date: Oct. 9, 2025

(54) Optimizing a Reference Group for Visual Inspection

(71) Applicant: Siemens Aktiengesellschaft, Muenchen (DE)

(72) Inventors: Yonatan HYATT, Tel Aviv (IL); Ofer NIR, Even Yehuda (IL); Ran GINSBURG, Ramat Gan (IL); Eyal NIMRODI, Tel Aviv (IL)

(21) Appl. No.: 18/864,057

(22) PCT Filed: Apr. 17, 2023
(86) PCT No.: PCT/IL2023/050400

§ 371 Date: Nov. 8, 2024

Related U.S. Application Data
(60) Provisional application No. 63/340,502, filed on May 11, 2022.

(30) Foreign Application Priority Data
May 11, 2022 (IL) 292960

(51) Int. Cl. G06T 7/00; G06V 20/52

(52) U.S. Cl. CPC G06T 7/001; G06V 20/52; G06T 2207/20081

(57) ABSTRACT

Methods and systems for visual inspection, wherein images of an item that can contribute to maximizing the relevance of reference images in a reference group to the inspection of the item are automatically detected, and wherein the detected images may be automatically added or removed to or from the reference group and, optionally, recommendations to a user on how to improve and optimize a reference group may be generated based on the detected images.

### CROSS-REFERENCE TO RELATED APPLICATIONS

This is a U.S. national stage of application No. PCT/IL2023/050400 filed 17 Apr. 2023. Priority is claimed on U.S. Application No. 63/340,502 filed 11 May 2022 and Israeli Application No. 292960 filed 11 May 2022, the content of which are incorporated herein by reference in their entirety.

### BACKGROUND OF THE INVENTION

### 1. Field of the Invention

The present invention relates to visual inspection processes for performing image-based inspection of items on a production/inspection line.

### 2. Description of the Related Art

Performing inspections during production processes helps control the quality of products by identifying defects and acting upon their detection, for example, by fixing them or discarding defected parts, and is thus useful in improving productivity, reducing defect rates, and reducing re-work and waste.

Traditionally, inspection tasks were performed by human workers. With the growing success of machine learning techniques, more and more of these tasks are now automated. Some automated visual inspection solutions compare an image of an inspected article to one or more reference images, in order to detect defects (or perform other inspection tasks) in an inspected article.

Reference images may be collected during a set up stage, prior to the inspection of the article, by sequentially imaging samples of the article. Typically, images captured sequentially will not significantly vary from each other. Thus, collecting a set of reference images that represents all possible variations of the inspected article may require collecting a large number of images and may be time consuming.

Contemporary automated visual inspection solutions fall short of satisfying industrial plants' need for agility and improvement.

### SUMMARY

Embodiments of the invention provide a method for optimizing a group of reference images (also referred to as “reference group”) used in a visual inspection process. Some embodiments of the invention provide a tool for a user (such as a technician, inspector and/or inspection line operator) to assist the user in optimizing the group of reference images.

Methods and systems in accordance with the embodiments of the invention automatically detect images of an item that can contribute to maximizing the relevance of reference images in a reference group to the inspection of the item. The detected images may then be automatically added or removed to or from the reference group. In some embodiments, recommendations to a user on how to improve and optimize a reference group may be generated based on the detected images. A recommendation generated based on this automatic detection typically includes suggesting to a user an action related to the reference group (e.g., adding or removing an image to or from the reference group), which is an action that can optimize the reference group. The recommendation may then be conveyed to a user, providing the user with a tool for optimizing the reference group without requiring the user to change or complicate his inspection routine.

Thus, embodiments of the invention streamline the inspection process for the user while maximizing accuracy and efficiency of the visual inspection process.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be described in relation to certain examples and embodiments with reference to the following illustrative figures so that it may be more fully understood, in which:

FIG. 1 schematically illustrates a system in accordance with embodiments of the invention;

FIGS. 2A and 2B schematically illustrate methods of optimizing a reference group, in accordance with embodiments of the invention;

FIGS. 3A, 3B and 3C schematically illustrate methods of optimizing a reference group, in accordance with additional embodiments of the invention; and

FIGS. 4A and 4B schematically illustrate methods for generating a recommendation regarding the reference group in accordance with a detected difference between the inspection image and previously captured images, in accordance with embodiments of the invention.

### DETAILED DESCRIPTION OF THE EXEMPLARY EMBODIMENTS

Embodiments of the invention provide methods and systems for optimizing a reference group for visual inspection of an item by analyzing images of same-type items, including an inspection image and previously captured images, and detecting a difference between the inspection image and the previously captured images and, in accordance with the detected difference, generating a signal regarding the reference group, e.g., a signal to add or remove an image to or from the reference group. The image may be added or deleted automatically, based on the generated signal. Alternatively or in addition, a recommendation regarding the reference group may be generated based on the signal and the recommendation may be conveyed to a user. Recommendations conveyed to a user may include, for example, a suggestion to add the inspection image to the reference group or, for example, to delete or remove a reference image from the reference group.

The automatic addition or deletion of an image to or from the reference group and/or recommendations to add or delete an image to or from the reference group, which are generated by a processor based on analysis of images of same-type items, effortlessly create a group of relevant images and/or provide a tool for the user to create a group of relevant images that can be used as a reference for inspection of these items.

The following terms will be used in the description:

“Setup stage” is a stage in a visual inspection process, in which images of examples of a same-type manufactured item (which is typically supplied by a user) are provided to a visual inspection machine for processing. The setup stage is typically an initial stage, followed by an inspection stage, but setup can also be performed after the inspection stage has begun.

“Inspection stage” is a stage, in the visual inspection process, which follows an initial setup stage, in which images of inspected items, which are of the same type as the examples used in the initial setup stage, are analyzed for inspection tasks.

“Inspection tasks” relate to functions of an inspection process, typically of the inspection stage, for example, defect detection, defect location, quality assurance, sorting and/or counting, gating, etc.

“Reference images” relates to images of items whose status has been confirmed by a user. For example, images obtained during a setup stage, may be considered “confirmed” because the items were supplied by a user. Additionally, images approved by a user (e.g., via a user interface device) as defect-free or defected, may be considered “confirmed”.

“Inspection images” relates to images of items that are of the same type as the examples used in a setup stage, however, items in an inspection image are of an unknown status.

“Status” of an item or image relates to inspection information results or predictions relevant to the imaged item. For example, a status of an item may be “defected” or “defect free” or “unknown”.

“Same-type items” refers to items or objects that are of the same physical makeup and are similar to each other in shape and dimensions and possibly color and other physical features. Typically, items of a single production series, batch of same-type items or batch of items in the same stage in its production line, may be “same-type items”. For example, if the inspected items are sanitary products, different sink bowls of the same batch arc same-type items.

A “defect” may include, for example, a visible flaw on the surface of the item, an undesirable size of the item or part of the item, an undesirable shape or color of the item or part of the item, an undesirable number of parts of the item, a wrong or missing assembly of interfaces of the item, a broken or burned part, and an incorrect alignment of the item or parts of the item, a wrong or defected barcode, serial number, text, icon, etc., and in general, any difference between the defect-free sample and the inspected item, which would be evident from the images to a user, namely, a human inspector. In some embodiments, a defect may include flaws that are visible only in enlarged or high-resolution images, e.g., images obtained by microscopes or other specialized cameras.

Additionally, in the following description, for purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “analyzing”, “processing,” “computing,” “calculating,” “determining,” “detecting” “identifying”, “learning” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Unless otherwise stated, these terms refer to automatic action of a processor, independent of and without any actions of a human operator.

A visual inspection process may include a setup stage and an inspection stage. In the setup stage, examples of a manufactured item of the same type and at a known status (e.g., defect-free items or defective items), are placed in succession within a field of view (FOV) of (one or more) cameras, to provide reference images.

In the inspection stage, which typically follows an initial setup stage, inspected items, which are of the same type as the items in the reference images and which are of an unknown status (e.g., may or may not have defects), are imaged, thereby providing inspection images. The inspection images are analyzed using computer vision techniques (e.g., machine learning processes) and are compared to the reference images to detect defects in the inspected items and/or for other inspection tasks.

In the set up stage, a processor learns set up parameters, such as, spatial properties and uniquely representing features or attributes of an item in images, as well as optimal parameters of images of the item, for example, optimal imaging or optical parameters (e.g., exposure time, focus and illumination). These parameters may be learned, for example, by analyzing images of a defect free item using different imaging parameters and by analyzing the relation between different images of a same type of defect-free item. This analysis during the set up stage provides the ability to discriminatively detect a same type of item (either defect free or with a defect) in a new image, regardless of the imaging environment of the new image, and provide the ability to continually optimize the imaging parameters with minimal processing time during the following inspection stage.

In one embodiment, the analysis of the set up images is used to determine a spatial range in which the item in the set up images shows no perspective distortion. The level of perspective distortion between items in different images can be analyzed, for example, by detecting regions in an item that do not have corresponding features between the set up images, by analyzing the intersection location and angles between the items' borders or marked areas of interest on the item, etc. The borders of the spatial range may be calculated by comparing two (or more) set up images (in which items may be positioned and/or oriented differently) and determining which of the images show perspective distortion and which do not.

The calculated range can then be used to determine the borders of where and/or in which orientation, scale or other dispositioning, an inspected item may be placed on the inspection line so as to avoid distortion. Additionally, by using a set of set up images as references for each other, the processor can detect images having similar spatial decomposition and this set of images can then be analyzed to see if there are enough similar set up images to allow registration, defect detection and other analyses for each possible position/location on the inspection line.

“Enough set up images” are collected when an essentially complete representation of a type of item is achieved. For example, when enough images are collected to enable determination of the spatial range in which each reference image can be used as a distortion-less reference, as described above, or when comparing the setup images to each other, no new tolerances or surface variations are discovered as new setup images are added.

Analysis of the set up images may be performed to collect information regarding possible 2D shapes and 3D characteristics (e.g., rotations on the inspection line) of an item or to find uniquely discriminative features of the item and the spatial relation between these unique features, as preserved between the set up images.

Based on the information collected from set up images, a processor can detect a second item of the same type and perform inspection tasks, even if the second item was not previously learned by the processor. This allows the processor to detect when a new item (of the same type) is imaged, and then to analyze the new item, for example, to search for a defect on an inspected item, based on the analysis of set up images.

Thus, a group of reference images for an inspected item should provide a more or less complete representation of a type of item, for maximizing accuracy of inspection of the item.

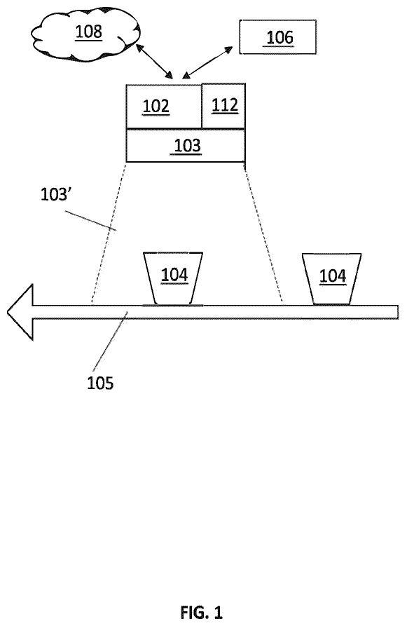

In one embodiment of the invention, which is schematically illustrated in FIG. 1, a system for visual inspection includes a processor 102 in communication with a camera 103 (one or more cameras) and a user interface (UI) device 106. The camera 103 captures images (e.g., reference images and inspection images) of same-type items 104, for example, on an inspection line 105. Inspection line 105 may include, for example, a conveyor belt on which items 104 are placed, such that movement of the conveyor belt brings the items, in succession, into the FOV 103′ of the camera 103. Images of the items may be displayed, e.g., via UI device 106, to a user, such as a technician, inspector and/or inspection line operator.

The captured images may be stored in storage device 108. Storage device 108 may store a reference group for items 104 (e.g., in a database of reference images) and/or may store other images of items 104, for example, inspection images may be stored in an inspection image database.

Components of the system may be in wired or wireless communication and may include suitable ports and/or network hubs. In some embodiments, processor 102 may communicate with devices, such as storage device 108 and/or user interface device 106, via a controller, such as a programmable logic controller (PLC), typically used in manufacturing processes, e.g., for data handling, storage, processing power, and communication capabilities. A controller may be in communication with processor 102, storage device 108, user interface device 106 and/or other components of the system, via USB, Ethernet, appropriate cabling, etc.

Processor 102 may include, for example, one or more processors and may be a central processing unit (CPU), a graphics processing unit (GPU), a digital signal processor (DSP), a field-programmable gate array (FPGA), a microprocessor, a controller, a chip, a microchip, an integrated circuit (IC), or any other suitable multi-purpose or specific processor or controller. Processor 102 may be locally embedded or remote.

The user interface device 106 may include a display, such as a monitor or screen, having a graphic user interface (GUI) for displaying images, instructions, recommendations and/or notifications to a user (e.g., via text or other content displayed on the monitor). In other embodiments, user interface device may include other or additional components by which to communicate instructions, recommendations and/or notifications to a user, e.g., a sound or light emitting component. User interface device 106 may also be configured to receive input from a user. For example, user interface device 106 may include a monitor and keyboard and/or mouse and/or touch screen, to enable a user to input feedback, instructions, etc.

Storage device 108 may be a server including, for example, volatile and/or non-volatile storage media, such as a hard disk drive (HDD) or solid-state drive (SSD). Storage device 108 may be connected locally or remotely, e.g., in the cloud. In some embodiments, storage device 108 may include software to receive and manage image data, e.g., reference images.

Camera 103 may include a CCD or CMOS or other appropriate image sensor. The camera 103 may be a 2D or 3D camera. In some embodiments, the camera 103 may include a standard camera provided, for example, with mobile devices such as smart-phones or tablets. In other embodiments, the camera 103 is a specialized camera, e.g., a camera for obtaining high resolution images or an ultra-violet, near-infra-red or infra-red specialized camera. In other embodiments, camera 103 includes a non-optical camera, such as a neutron camera, a RADAR camera, and the like.

The system may also include a light source, such as an LED or other appropriate light source, to illuminate the FOV 103′ of the camera 103, e.g., to illuminate item 104 on the inspection line 105.

Processor 102 receives image data (which may include data such as pixel values that represent the intensity of reflected light as well as partial or full images or videos) of items 104 on the inspection line 105 from one or more camera(s) 103 and runs processes in accordance with embodiments of the invention.

Processor 102 is typically in communication with a memory unit 112. Memory unit 112 may store at least part of the image data received from camera 103. Memory unit 112 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

In some embodiments, the memory unit 112 stores executable instructions that, when executed by processor 102, facilitate performance of operations of processor 102, as described herein.

In another embodiment, processor 102 detects a difference between an inspection image of an item and previously captured images of items In accordance with the detected difference, processor 102 may generate a signal regarding the group of reference images of items (e.g., a signal to automatically add or remove an image from the reference group). In some embodiments, processor 102 generates a recommendation to a user, based on the detected difference, and causes the recommendation to be conveyed to the user, e.g., via the user interface device 106.

A user may provide, during a set up stage, a small number of confirmed items 104 to be imaged by camera 103 and/or the user may confirm a small number of images of items 104 captured by camera 103. The images of confirmed items or confirmed images may include images of defect-free and/or defected items. The user may then go on to provide an item 104 of unknown status to be imaged by camera 103. The confirmed images will be grouped into a reference group by processor 102 (e.g., in storage device 108), whereas the image of item 104 of unknown status (namely, an inspection image of item 104) will be checked for differences between it and the images previously captured by camera 103 (in this case the images in the reference group). If a difference is detected, then processor 102 generates a signal regarding the reference group. Based on the signal, an automatic action may be performed on the reference group (e.g., an image may be added or removed from the reference group) or a recommendation to the user may be generated, which can assist the user in optimizing the reference group. The automatic action or recommendation generated by the processor streamlines the inspection process for the user while not requiring the user to change or complicate his inspection routine.

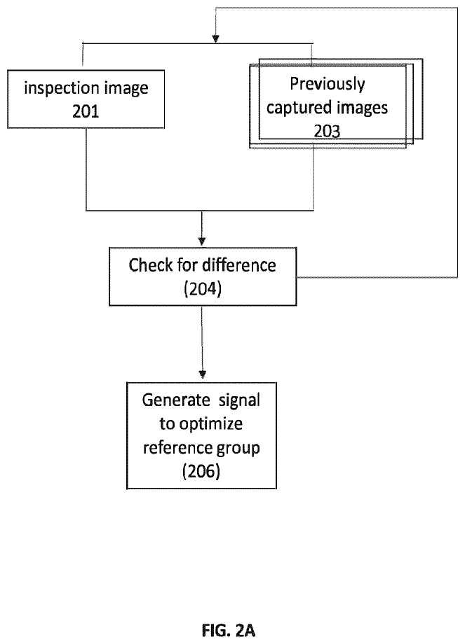

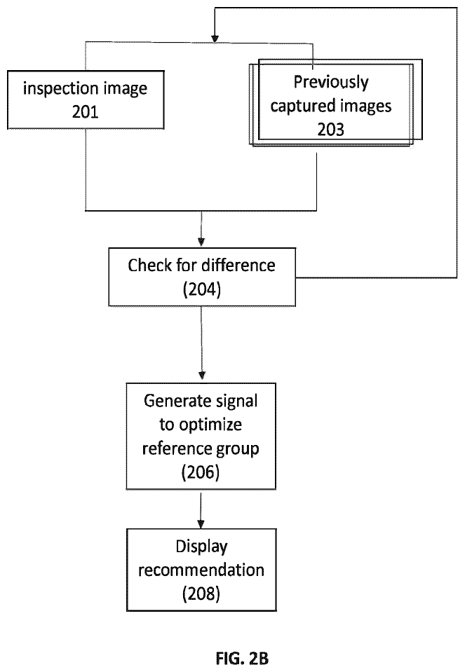

In one example, which is schematically illustrated in FIGS. 2A and 2B, optimizing a reference group, may include providing for analysis by processor 102, an inspection image 201 and previously captured images 203. The previously captured images 203 may include reference images and/or previous inspection images. Typically, the reference images include images confirmed by a user, as described above. In one embodiment, the previously captured images include images of defect-free same-type items. In another embodiment, the previously captured images include images of defective same-type items. In other embodiments, images of unknown status may be included in the previously captured images.

Processor 102 checks for a difference or variation between the inspection image 201 and the previously captured images 203 (step 204). In accordance with the detected difference, processor 102 generates a signal to optimize the reference group (step 206). For example, the processor 102 determines whether to add or remove an image from the reference group and generates a signal accordingly. Processor 102 may then cause an automatic action based on the signal.

In another embodiment, which is schematically illustrated in FIG. 2B, based on the signal generated in step 206, processor 102 may cause a recommendation regarding the reference group, to be conveyed to the user (step 208). For example, if a predefined difference is detected, then a recommendation is generated and conveyed to the user, typically via UI device 106. For example, the recommendation may be displayed on a monitor to the user. If the predefined difference is not detected in step 204 and/or a signal regarding the reference group is not generated in step 206, then no recommendation is generated or displayed and inspection image 201 is added to the previously captured images 203 and a new inspection image is checked for differences from the previously captured images 203. This process may continue until a complete representation of the item is achieved in the reference group. In some embodiments, achieving a complete representation is a time-based process (e.g., complete representation is achieved after a predetermined or calculated time has passed) and/or based on a number of collected images (e.g., complete representation is achieved after a predetermined or calculated number of images has been collected).

The difference or variation checked by the processor may be based on statistical values of the parameters or features being compared between the inspection image 201 and previously captured images 203.

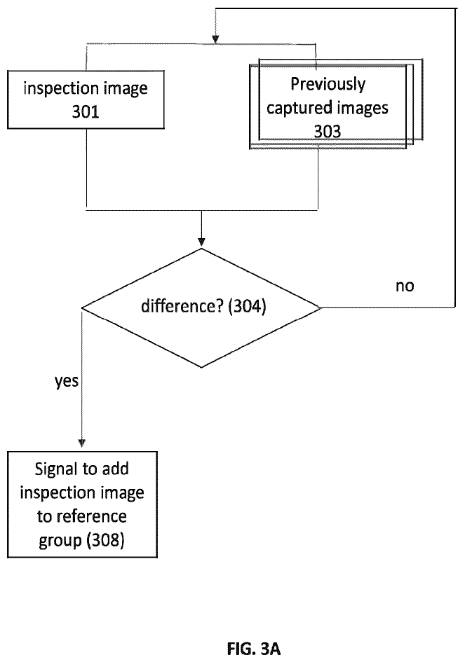

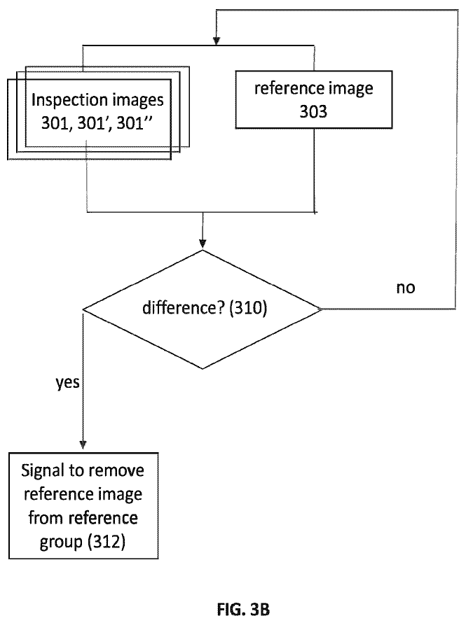

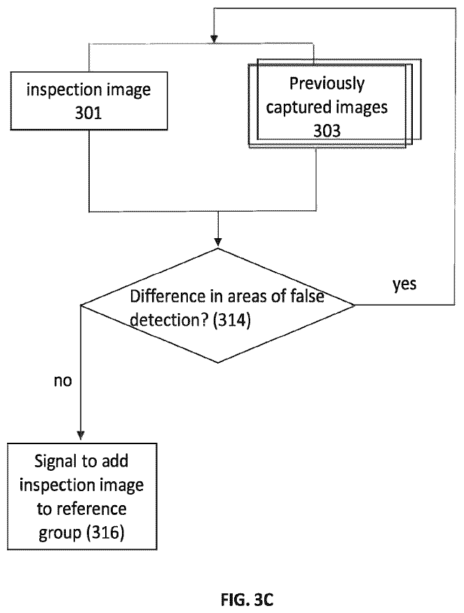

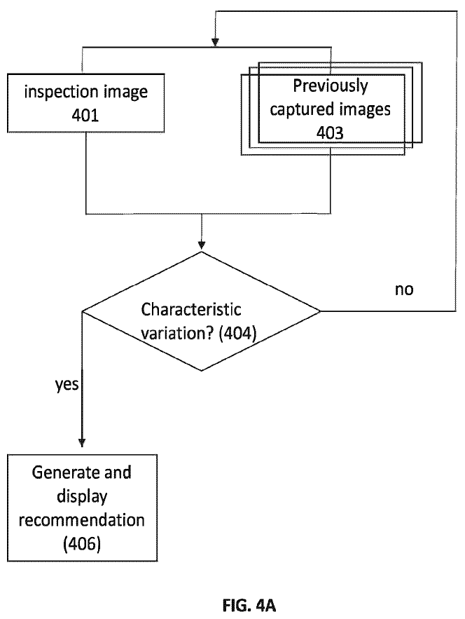

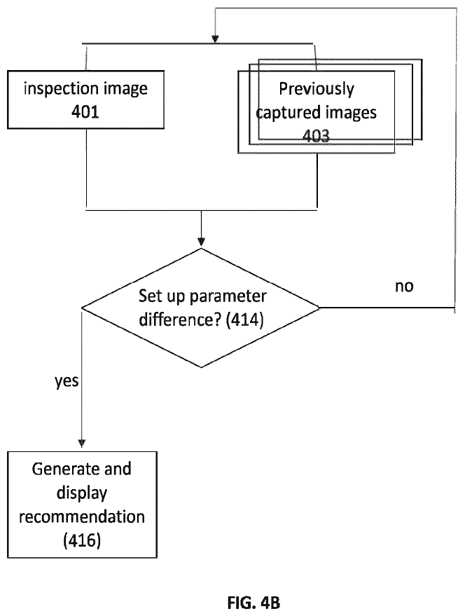

The difference (one or more) checked for in step 204 may be a difference above a threshold. In other embodiments, the difference (one or more) checked for in step 204 may be a difference below a threshold. Some examples are schematically illustrated in FIGS. 3A-3C. In some embodiments, the threshold may be dependent on the level of variability between the items 104, as further exemplified in FIGS. 4A and 4B.

In one embodiment, which is schematically illustrated in FIG. 3A, processor 102 checks for a difference or variation between an inspection image 301 and previously captured images 303 (step 304) and, if a difference is detected (e.g., a difference above a threshold), then processor 102 generates a signal (and possibly conveys a recommendation to the user) to add the inspection image 301 to the reference group (step 308). The presently contemplated embodiment ensures that significantly different images will be included in the reference group thereby providing better representation to all possible variations of the item, e.g., item 104. Variations in images of item 104 may exist due to numerous reasons, such as different users performing the inspection, different incoming materials, different ambient conditions (e.g., day/night). These variations may not be fully represented in the small number of initial confirmed images that initially constitute the reference group, thus, adding to the reference group images that are different (e.g., above a threshold) than the images already in the reference group, helps to optimize the reference group.

In another embodiment, which is schematically illustrated in FIG. 3B, in step 310, processor checks for a difference or variation between an inspection image or a plurality of inspection images 301, 301′ 301″ etc., and a previously captured image 303 (a reference image, in this example). If a difference is detected (e.g., a difference above a threshold), then processor 102 generates a signal (and possibly conveys a recommendation to the user) to remove the reference image (previously captured image 303) from the reference group (step 312). The presently contemplated embodiment ensures reference images that are no longer relevant to the inspected item are not continued to be used as references. For example, an inspected item may change significantly over time (e.g., due to changes in production materials, changes in ambient conditions, etc.), such that the items imaged in the initial reference images, may no longer be useful as reference images and should be removed from the reference group.

Another embodiment, which is schematically illustrated in FIG. 3C, refers to an example where a specific area or feature of the imaged item is falsely detected as a defect or causes defects to be falsely determined, in images of the reference group. In step 314, processor 102 checks for a difference or variation between an inspection image 301 and previously captured images 303 (reference images, in this example). In this example, the difference checked for in step 314 is a difference in the specific area or feature that causes false detection of defects. If there is no difference or a small difference between the area or feature in the inspection image 301 and the reference images 303, then adding the inspection image to the reference group would increase the number of different images having an area or feature that causes false detection of defects, providing better representation of the different variations of the specific area or feature. Thus, if in step 314 a difference not detected (e.g., a difference below a threshold), then processor 102 generates a signal (and possibly conveys a recommendation to the user) to add the inspection image 301 to the reference group (step 316).

In one embodiment, which is schematically illustrated in FIG. 4A, the difference between an inspection image and previously captured images includes a variation in a characteristic between the inspection image and the previously captured images. Thus, processor 102 checks for a variation in a characteristic between the inspection image 401 and previously captured images 403 (step 404) and generates a signal (and possibly conveys a recommendation to the user) regarding the reference group (step 406), e.g., to add the inspection image to the reference group or to remove a reference image from the reference group.

The variation in characteristic may include, for example, a difference between a parameter of the item in the inspection image and a parameter of the same-type items in the previously captured images. A parameter may include, for example, a correlation score, a visual resemblance score, a number of areas of anomaly, a prediction of defects in an area of anomaly, features used by machine learning algorithms to describe the item and location of the anomalies on the item.

Thus, a method in accordance with one embodiment, may include comparing previously captured images 403 to each other to obtain a correlation score (e.g., a score of visual resemblance or other resemblances which may not be visible, such as correlation of statistical features) of the previously captured images to themselves, and if a difference is detected between a correlation score of the inspection image 401 to the previously captured images 403 and the correlation score of the previously captured images to themselves, then a signal (e.g., as described above) is generated and a recommendation may be conveyed to the user (step 406).

In yet another embodiment, the method includes comparing previously captured images 403 to each other to obtain a number of areas of anomaly in same-type items, and if there is a difference between the number of areas of anomaly in the inspection image 401 and the number of areas of anomaly in the same-type items in the previously captured images, then a signal (e.g., as described above) is generated and a recommendation may be conveyed to the user (step 406).

In yet a further embodiment, the method includes obtaining a prediction of defects (e.g., by using machine learning algorithms as described below) in an area of anomaly in the previously captured images 403, and if there is a difference between a prediction of defects in the areas of anomaly in the inspection image 401 and the prediction of defects in the area of anomaly in the previously captured images 403, then a signal (e.g., as described above) is generated and a recommendation may be conveyed to the user (step 406).

Machine learning algorithms used to obtain a prediction of defects, in accordance with embodiments of the invention, may include, for example, detecting blobs of suspected defects in an inspection image and blobs of suspected defects in one or more previously captured images (e.g., a group of pixels at a location in an inspection image differing from pixels at the same location in a reference image). If the distance between the blobs is above a threshold, then a signal may be generated to add the inspection image to the reference group. If, for example, the blob in the inspection image is at a distance below a threshold to an area (blob) in a previously captured image, where a defect was falsely detected, then a signal may be generated to add the inspection image to the reference group.

In some embodiments, the variation in the characteristic includes a difference between features used by machine learning algorithms to describe the item (and possibly locations of anomalies on the item) in the inspection image 401 and features used by the machine learning algorithms to describe the same-type items (and possibly locations of anomalies on the same type items) in the previously captured images 403. Thus, if there is a difference between features used by machine learning algorithms to describe the item in the inspection image and features used by the machine learning algorithms to describe the same-type items in the previously captured images, then a signal (e.g., as described above) is generated and a recommendation may be conveyed to the user (step 406).

Features used by machine learning algorithms to describe an item and/or locations of anomalies on items, may include, for example, outputs of intermediate layers of a deep learning network (e.g., outputs used for auxiliary losses in down scaled versions of the image). Thus, if such outputs used for an inspection image are different than the outputs used for one or more previously captured image, then a signal may be generated accordingly.

In one embodiment, which is schematically illustrated in FIG. 4B, the difference between an inspection image and previously captured images is related to a set up parameter. In this embodiment, processor 102 checks for differences in one or more set up parameters between the inspection image 401 and the previously captured images 403 (step 414) and in accordance with the difference, generates a signal (and possibly conveys a recommendation to a user) regarding the reference group (step 416), e.g., to add the inspection image to the reference group or to remove a reference image from the reference group.

Set up parameters may include, for example, 3D location of the item in the image or optical parameters of images of the item (e.g., as described above). Thus, in one embodiment, the difference determined in step 414 is a variation between the 3D location of the item in the inspection image and the 3D location of the same-type items in the previously captured images.

In another embodiment, the difference determined in step 414 is a variation between optical parameters of the inspection image and optical parameters of the previously captured Images.

Some differences or variations may have a broad range of tolerance (a high level of variability between the same-type items) and thus, a threshold for determining if images vary or arc different may be high or low depending on the tolerance of the difference or variation that is being checked as well as based on the type of item.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-21. (canceled)

22. A method for optimizing a reference group, the reference group comprising reference images of same type items, and the reference images being compared with an inspection image to perform visual inspection of an item in the inspection image, the method comprising:
detecting a difference between the inspection image and previously captured images; and
generating a signal to add or remove an image from the reference group in accordance with the detected difference.

23. The method of claim 22, wherein the previously captured images comprise reference images.

24. The method of claim 22, wherein the previously captured images comprise inspection images.

25. The method of claim 22, wherein the reference group comprises images of defect-free same-type items.

26. The method of claim 22, wherein the reference group comprises images confirmed by a user.

27. The method of claim 22, further comprising:
detecting a difference above a threshold;
wherein the threshold is dependent on a level of variability between the same-type items.

28. The method of claim 22, wherein the difference comprises a variation in a characteristic between the inspection image and the previously captured images.

29. The method of claim 28, wherein the variation in the characteristic comprises a difference between a parameter of the item in the inspection image and a parameter of the same-type items in the previously captured images.

30. The method of claim 29, further comprising:
comparing the previously captured images to each other to obtain a correlation score of the previously captured images to themselves;
wherein the variation in the characteristic comprises a difference between a correlation score of the inspection image to the previously captured images and the correlation score of the previously captured images to themselves.

31. The method of claim 29, further comprising:
comparing the previously captured images to each other to obtain a number of areas of anomaly in the same-type item;
wherein the variation in the characteristic comprises a difference between a number of areas of anomaly in the inspection image and the number of areas of anomaly in the same-type item.

32. The method of claim 29, further comprising:
obtaining a prediction of defects in an area of anomaly in the previously captured images;
wherein the variation in the characteristic comprises a difference between a prediction of defects in the areas of anomaly in the inspection image and the prediction of defects in the area of anomaly in the previously captured images.

33. The method of claim 29 wherein the variation in the characteristic comprises a difference between features utilized by machine learning algorithms to describe the item in the inspection image and features utilized by the machine learning algorithms to describe the same-type items in the previously captured images.

34. The method of claim 22, wherein the difference is related to a set up parameter.

35. The method of claim 34, wherein the difference comprises a variation between a 3D location of the item in the inspection image and a 3D location of the same-type items in the previously captured images.

36. The method of claim 34, wherein the difference comprises a variation between optical parameters of the inspection image and optical parameters of the previously captured images.

37. The method of claim 22, wherein the generated signal indicates the inspection image should be added to the reference group.

38. The method of claim 22, wherein the previously captured images comprise reference images; and wherein the method further comprises:
detecting a difference between the inspection image and a reference image; and
generating a signal to remove the reference image from the reference group in accordance with the detected difference.

39. The method of claim 38, further comprising:
detecting a difference between a plurality of inspection images and a reference image.

40. The method of claim 22, further comprising:
conveying to a user a recommendation regarding the reference group based on the generated signal.

41. A system for visual inspection, the system comprising:
a processor operatively coupled to a camera which captures reference images and inspection images of same-type items; and
a user interface operatively coupled to the processor;
wherein the processor detects a difference between an inspection image and previously captured images of same-type items and, in accordance with the detected difference, generates a signal to add or remove an image from a reference group.

42. The system of claim 41, wherein the processor causes conveyance of a recommendation to add or remove an image from the reference group to a user via the user interface.
